(19) United States
(12) Patent Application Publication
(10) Pub. No.: US 2011/0075348 A1
(43) Pub. Date: Mar. 31, 2011

(54) MOUNTING APPARATUS FOR DISK DRIVE

(75) Inventor: ZHAN-YANG LI, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/690,346

(22) Filed: Jan. 20, 2010

(30) Foreign Application Priority Data
Sep. 30, 2009 (CN) 200920311964.2

(51) Int. Cl. G06F 1/16

(52) U.S. Cl. 361/679.33

(57) ABSTRACT

A mounting apparatus is used to secure a disk drive, which has a positioning post, and includes a bracket and a locking component. The bracket is configured for receiving the disk drive, and includes a first sidewall, the first sidewall defining a guiding slot. The locking component includes a main body secured to an outer surface of the first sidewall. A convex structure is located on the main body, and includes a first portion, a second portion and a third portion. A distance is defined between the second portion and the first sidewall and great enough to allow the positioning post pass underneath. A resiliently deformable locking piece extends from the convex structure and substantially adjacent the guiding slot. The locking piece engages with the positioning post.

### BACKGROUND

1. Technical Field

The present disclosure relates to a mounting apparatus for securing a disk drive.

2. Description of Related Art

A disk drive is often secured to a chassis of a computer. The chassis includes a bracket defining through holes. The disk drive defines a plurality of screw holes corresponding to the through holes of the bracket. A plurality of screws is screwed into the through holes and the screw holes to fix the disk drive to the bracket. This conventional means for securing the disk drive by screws is very inconvenient.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric, partial view of a mounting apparatus and a disk drive in accordance with an embodiment.

FIG. 2 is similar to FIG. 1, but viewed from a different aspect.

FIG. 3 is an assembled view of FIG. 1.

FIG. 4 is an assembled view of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

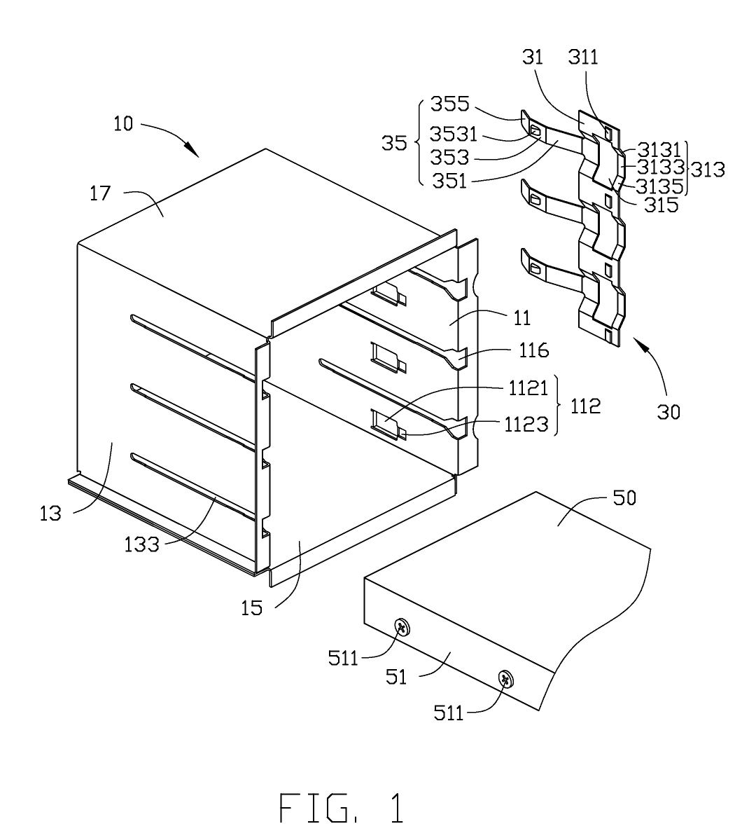

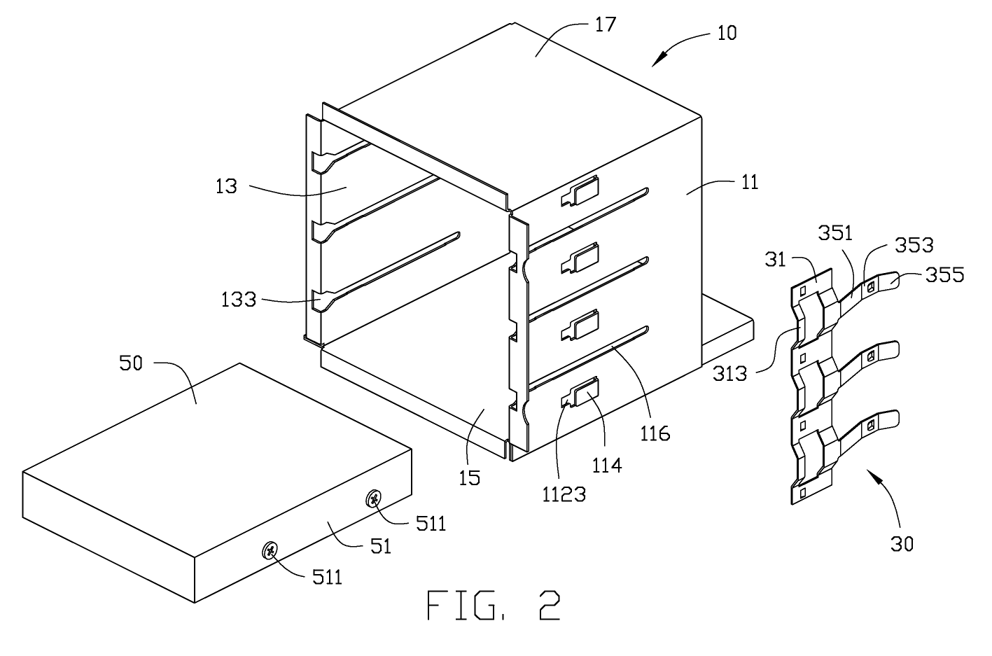

Referring to FIGS. 1-2, a mounting apparatus in accordance with an embodiment is capable of securing a plurality of disk drives 50 (only one disk drive shown in FIG. 1). Each disk drive 50 includes two parallel disk drive sidewalls 51, and two positioning posts 511 are located on each disk drive sidewall 51. The mounting apparatus includes a bracket 10 and a locking component 30 configured to be secured to the bracket 10.

The bracket 10 includes a bottom wall 15, a first sidewall 11, and a second sidewall 13, and a top wall 17 substantially parallel to the bottom wall 15. The bottom wall 15, the first sidewall 11, the second sidewall 13 and the top wall 17 together define a holding space configured to receive the disk drives 50. The first sidewall 11 is substantially parallel to the first sidewall 11 and perpendicular to the bottom wall 15. A plurality of guiding slots 116 is defined in the first sidewall 11, and extends in a first direction substantially parallel to the bottom wall 15. A plurality of locking gaps 112 is defined in the first sidewall 11, and arranged in a second direction perpendicular to the bottom wall 15. Each guiding slot 116 is located between each two locking gaps 112. Each locking gap 112 includes a big portion 1121 and a small portion 1123. The small portion 1123 is located at a front edge of the big portion 1121 and in communication with the big portion 1121. A resiliently deformable positioning piece 114 is bent outward from a rear edge of the big portion 1121 to define a distance between the positioning piece 114 and the first sidewall 11. The second sidewall 13 defines a plurality of guiding slots 133, and each guiding slot 133 has a structure substantially the same as each guiding slot 116 of the first sidewall 11. The guiding slots 116 of the first sidewall 11 and the guiding slots 133 of the second sidewall 13 are together used to receive the positioning posts 511 of the disk drives 50.

The locking component 30 includes a main body 31 and a plurality of locking pieces 35. A plurality of locking tabs 311 is located on the main body 31 and arranged in a vertical direction. Each locking tab 311 is configured to engage in the small portion 1123 of the lock gap 112 of the first sidewall 11 of the bracket 10. A plurality of convex structures 313 is bent outward from the locking component 30, corresponding to the guiding slots 116 of the first sidewall 11 of the bracket 10. Each convex structure 313 is located between two adjacent locking tabs 311, and includes a first portion 3131, a second portion 3133, and a third portion 3135. The second portion 3133 is substantially parallel to the main body 31, and connected between the first portion 3131 and the third portion 3135. The first portion 3131 and the third portions 3135 are respectively connected between the main body 31 and the second portion 3133. A through opening 315 is defined in each convex structure 313. Each locking piece 35 extends from a rear edge of each second portion 3133, and includes: a first segment 351 extending diagonally inwards from the second portion 3133, a second segment 353 extending from a rear edge of the first segment 351, and a third segment 355 extending diagonally outward from a rear edge of the second segment 353. The second segment 353 is substantially parallel to the main body 31. A locking protrusion 3531 is located on the second segment 353 of each locking piece 35.

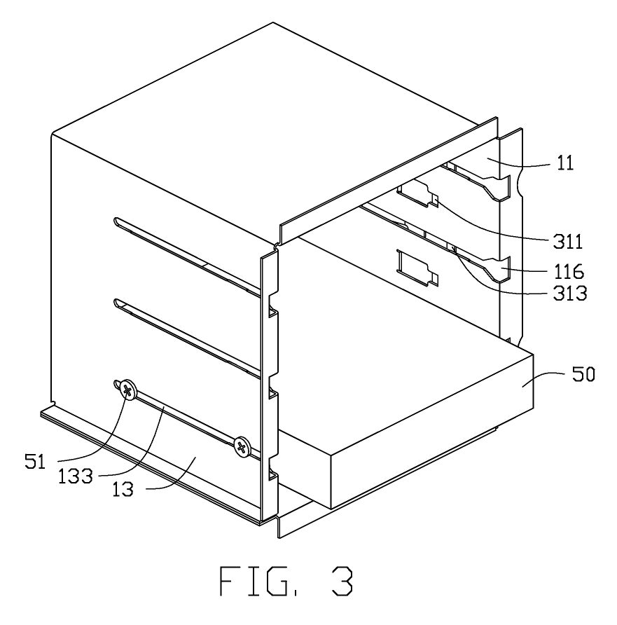

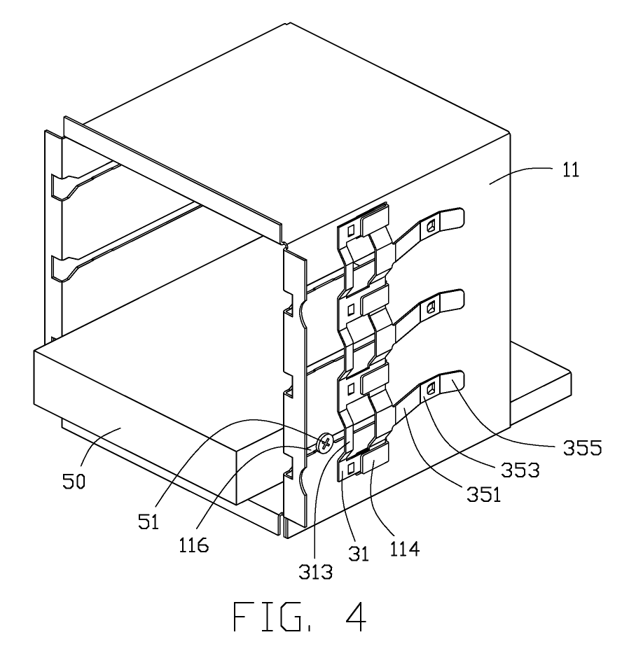

Referring also to FIGS. 3-4, in assembling the locking component 30 to the bracket 10, the locking component 30 is placed on an outer surface of the first sidewall 11. The main body 31 is inserted in the distance between the positioning piece 114 and the first sidewall 11. The locking component 30 is slid towards a rear edge of the first sidewall 11, until the locking tabs 311 are engaged in the small portions 1123 of the locking gaps 112. Therefore, the locking component 30 is secured to the first sidewall 11. The second portion 3133 is substantially parallel to the first sidewall 11, and a distance is defined between the second portion 3133 of each convex structure 313 and the first sidewall 11. Each locking piece 35 of the locking component 30 is located at one side of the guiding slot 116. The locking piece 35 has an un-actuated original position, where the locking protrusion 3531 is substantially adjacent to the guiding slot 116 of the first sidewall 11.

In assembly of the disk drive 50, the positioning posts 511 of the disk drive 50 are inserted in the guiding slot 116 of the first sidewall 11 and the guiding slot 133 of the second sidewall 13. The disk drive 50 is slid in the bracket 10 from front to rear. When one positioning post 511 of the disk drive 50 abuts against the locking protrusion 3531 of the locking piece 35, the disk drive 50 is further pushed in the bracket 10, to urge the one positioning post 511 to press the locking protrusion 3531. The locking piece 35 is therefore resiliently deformed away from the first sidewall 11. After the one positioning post 511 of the disk drive 50 passes across the locking protrusion 3531 and abuts against the rear end of the guiding slot 116, the locking piece 35 resiliently rebounds to the original position. The one positioning post 511 is blocked between the rear end of the guiding slot 116 and the locking protrusion 3531. The disk drive 50 is secured in the bracket 10.

In disassembly of the disk drive 50, the third segment 355 of the locking piece 35 is operated to resiliently deform the locking piece 35 away from the original position, until the positioning posts 511 of the disk drive 50 can be slid across the locking protrusion 3531. Thus, the disk drive 50 can be taken away from the bracket 10.

In one embodiment, the locking component 30 may be, for example, made of a thin metal piece.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A mounting apparatus for a disk drive, the disk drive having a positioning post, the mounting apparatus comprising:
a bracket configured for receiving the disk drive, the bracket comprising a first sidewall, the first sidewall defining a guiding slot; and
a locking component comprising a main body secured to an outer surface of the first sidewall; a convex structure located on the main body; the convex structure comprising a first portion, a second portion and a third portion; the first portion and the third respectively connecting the main body and the second portion; a distance defined between the second portion and the first sidewall and configured to allow the positioning post to pass; a resiliently deformable locking piece extending from the convex structure and substantially adjacent the guiding slot, and the locking piece being configured to engage with the positioning post.

2. The mounting apparatus of claim 1, wherein the second portion is parallel to the first sidewall.

3. The mounting apparatus of claim 1, wherein a locking protrusion is located on the locking piece for engaging with the positioning post.

4. The mounting apparatus of claim 3, wherein the locking piece comprises of a first segment, a second segment and a third segment; the first segment extends diagonally towards the first sidewall; the third segment extends diagonally away from the first sidewall; and the second segment is connected between the first segment and the third segment.

5. The mounting apparatus of claim 4, wherein the locking protrusion is located on the second segment.

6. The mounting apparatus of claim 4, wherein the second segment is substantially parallel to the first sidewall.

7. The mounting apparatus of claim 1, wherein a plurality of locking tabs is located on the main body of the locking component; the first sidewall defines a plurality of locking gaps; each locking gap comprises a big portion a small portion in communication with the big portion; and the small portions receive the locking tabs of the locking component.

8. The mounting apparatus of claim 7, wherein a positioning piece is located on an edge of the big portion of each locking gap; a distance is defined between each locking piece and the first sidewall; and the main body of the locking component is positioned between each locking piece and the first sidewall.

9. A mounting apparatus for a disk drive, the disk drive having a positioning post, the mounting apparatus comprising:
a bracket configured for receiving the disk drive, the bracket comprising a first sidewall, the first sidewall defining a guiding slot; and
a locking component comprising a main body secured to an outer surface of the first sidewall and a resiliently deformable locking piece; a convex structure located on the main body; a distance defined between the convex structure configured to allow the positioning post to pass; a locking protrusion located on locking piece and substantially adjacent the guiding slot of the first sidewall;
wherein the locking protrusion of the locking component and an end of the guiding slot of the first sidewall are configured to position the positioning post therebetween.

10. The mounting apparatus of claim 9, wherein the convex structure comprises a first portion, a second portion and a third portion; the first portion and the third respectively connects the main body and the second portion; and the distance is defined between the second portion and the first sidewall.

11. The mounting apparatus of claim 10, wherein the second portion is parallel to the first sidewall.

12. The mounting apparatus of claim 9, wherein the locking piece comprises of a first segment, a second segment and a third segment; the first segment extends diagonally towards the first sidewall; the third segment extends diagonally away from the first sidewall; and the second segment is connected between the first segment and the third segment.

13. The mounting apparatus of claim 12, wherein the locking protrusion is located on the second segment.

14. The mounting apparatus of claim 12, wherein the second segment is substantially parallel to the first sidewall.

15. The mounting apparatus of claim 9, wherein a plurality of locking tabs is located on the main body of the locking component; the first sidewall defines a plurality of locking gaps; each locking gap comprises a big portion and a small portion in communication with the big portion; and the small portions are configured to receive the locking tabs of the locking component.

16. The mounting apparatus of claim 15, wherein a positioning piece is located on an edge of the big portion of each locking gap; a distance is defined between each locking piece and the first sidewall; and the main body of the locking component is positioned between each locking piece and the first sidewall.
